(19) United States
(12) Patent Application Publication
(10) Pub. No.: US 2007/0138267 A1
(43) Pub. Date: Jun. 21, 2007

(54) Public terminal-based translator

(76) Inventor: Debra Lin Singer-Harter, Raleigh, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/314,918

(22) Filed: Dec. 21, 2005

(51) Int. Cl. G06K 15/00; G06Q 20/00

(52) U.S. Cl. 235/383; 705/16

(57) ABSTRACT

A method, system and computer-program for providing translated answers to foreign language speakers is presented. The method includes the steps of receiving, at a public terminal, a verbal input from a customer speaking a foreign language, the foreign language being unintelligible to an operator of the public terminal; translating, by the public terminal, the verbal input into a language that has been predetermined as being understandable by a specific operator of the public terminal; and presenting the translated verbal input to the specific operator.

### BACKGROUND OF THE INVENTION

1. Technical Field

The present invention relates in general to the field of computers and similar technology systems, and in particular to software utilized by such systems to implement methods and processes. Still more particularly, the present invention relates to the field of computer terminals and their use in overcoming spoken language barriers.

2. Description of the Related Art

Point-Of-Sale (POS) terminals, also referred to as “check-out stations,” are computer terminals in retails stores, typically located at or near a store exit, at which store employees receive payment from customers for purchased goods. Oftentimes, however, the locations of POS terminals are where customers ask store employees (who are operating the POS terminals) questions related to products, the store, sales, etc.

In cosmopolitan areas, customers are often from varied cultures and/or countries, resulting in multiple languages being spoken by the customers. To adequate serve such customers, stores are under the burden to either hire enough varied multilingual employees to staff the POS terminals, or else risk alienating customers who are unable to obtain adequate levels of personal service due to language barriers.

### SUMMARY OF THE INVENTION

Recognizing the problems presented in assisting foreign language speakers in public facilities, including stores, a method, system and computer-program for providing translated answers to foreign language speakers' questions is presented. The method includes the steps of receiving, at a public terminal, a verbal input from a customer speaking a foreign language, the foreign language being unintelligible to an operator of the public terminal; translating, by the public terminal, the verbal input into a language that has been predetermined as being understandable by a specific operator of the public terminal; and presenting the translated verbal input to the specific operator.

In one embodiment, the method further includes the steps of storing in the public terminal a list of foreign languages that are not understood by the specific operator; and using software that is associated with the public terminal to recognize the verbal input as being in a language from the list of foreign languages that are not understood by the specific operator.

In another embodiment, the verbal input is a verbal question presented to a store employee via a microphone on a Point-Of-Sale (POS) terminal, and the method further includes the steps of storing a list of predetermined questions that may be asked by foreign language speaking customers; storing a list of resources, wherein each resource in the list of resources corresponds to, and provides an answer to, one of the predetermined questions; matching an appropriate resource from the list of resources to a verbal question asked by the customer; and presenting the appropriate resource to the customer. The questions may be about products, stores (which support the public terminal), or other environments in which the public terminal is located.

The appropriate resource may be a graphics file that is presented to the customer visually at the POS terminal, or a text file related to information about a product being paid for at the POS terminal.

In another embodiment, the features described and used by the POS terminal are utilized in a kiosk and a self checkout system, as well as a RFID communication device, a tablet computer, a cell phone, a hand-held device (e.g., a Personal Digital Assistants—PDA) and/or any like device that communicates between a consumer and a retailer, etc.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary Graphical User Interface (GUI) displayed at a computer in which the present invention is implemented;

FIG. 2a illustrates translation and database search logic associated with the computer;

FIG. 2b depicts an exemplary database containing a list of foreign languages that are not understood by a manager of the computer, and a list of answers to predetermined questions that may be asked by a foreign language speaker;

FIG. 3 illustrates a flow-chart of exemplary steps taken to allow a foreign language speaker to communicate with the manager of the computer;

FIG. 4 depicts an exemplary computer in which the present invention may be implemented;

FIG. 5 illustrates an exemplary server from which software for executing the present invention may be deployed;

FIGS. 6a-b show a flow-chart of steps taken to deploy software capable of implementing the display, database and steps shown and described in FIG. 1-3;

FIGS. 7a-c show a flow-chart of steps taken to deploy in a Virtual Private Network (VPN) software that is capable of implementing the display, database and steps shown and described in FIG. 1-3;

FIGS. 8a-b show a flow-chart showing steps taken to integrate into an computer system software that is capable of implementing the display, database and steps shown and described in FIG. 1-3; and

FIGS. 9a-b show a flow-chart showing steps taken to implement the display, database and steps shown and described in FIG. 1-3 using an on-demand service provider.

### DETAILED DESCRIPTION OF THE PREFERRED EMBODIMENT

The present invention relates, inter alia, to a method and system that permit communication across a language barrier between two persons. For exemplary persons, the invention is described in the context of a customer and a store employee attempting to communicate at and via a Point-Of-Sale (POS) terminal in a retail store. However, it should be understood that the present invention is implementable in, and the scope of the claims include, any environment in which a speech-recognition capable computer is available to permit communication between two persons having a language barrier between them.

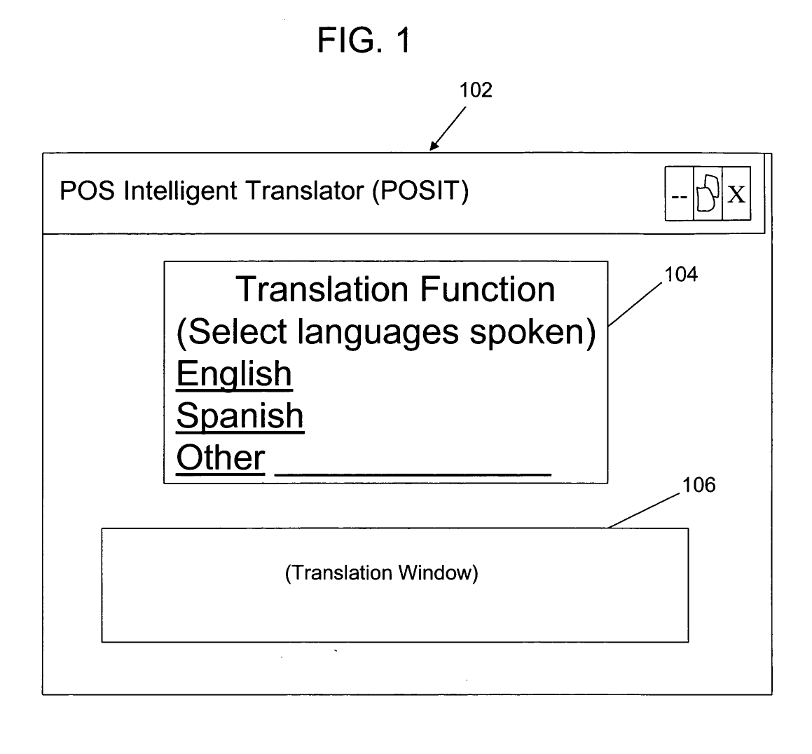

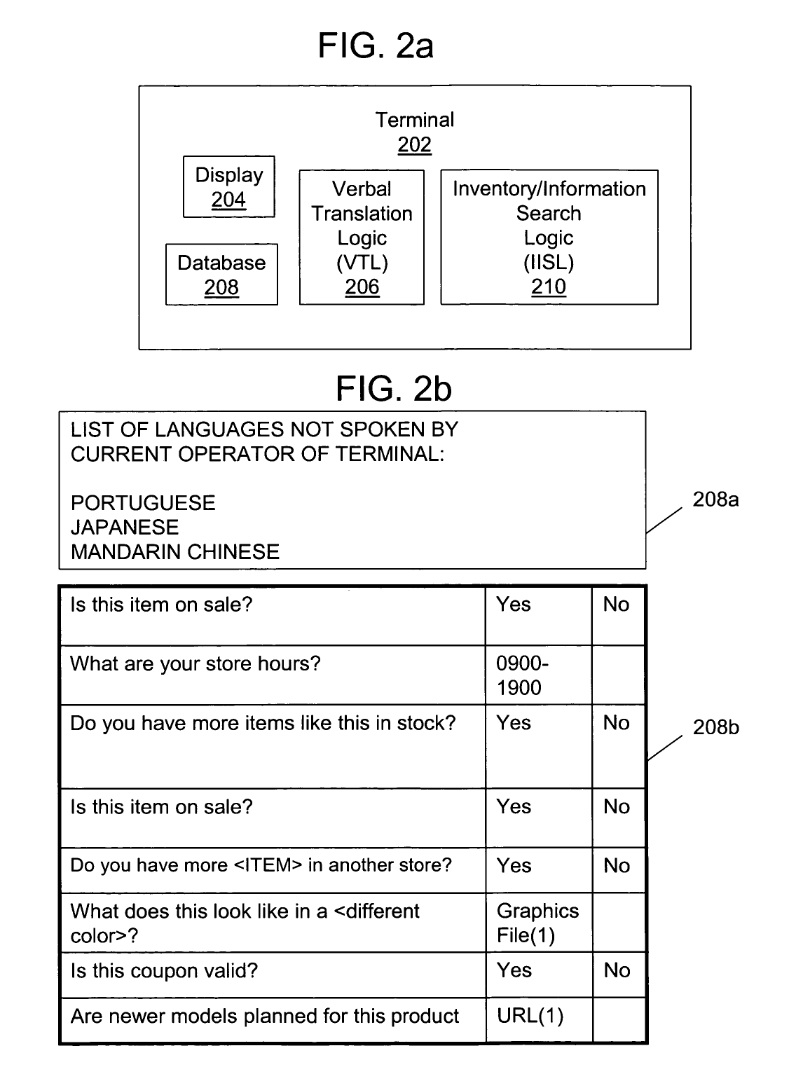

With reference now to the figures, and in particular to FIG. 1, an exemplary Graphical User Interface (GUI) 102, which is on a monitor of a Point-Of-Sale (POS) terminal in a retail store, is illustrated. In a preferred embodiment, GUI 102 is visible to a customer as well as an employee of the retail store who is operating/managing the POS terminal. Assuming GUI 102 is visible to the store employee, window 104 permits the store employee to enter which language(s) he/she speaks. A database (shown below in FIG. 2b) uses this information (by simply subtracting the list of languages entered into window 104 from a list of all languages, which are supported by Verbal Translation Logic (VTL) 206, found in database 208) to determine which languages need translations. Thus, when a microphone on the POS terminal picks up spoken words from a customer, use of this database will permit an automatic determination of whether a translation for those spoken words is necessary according to the language skills of the store employee. If such translation is needed, then the translation will be displayed in translation window 106 in any language selected by the store employee in window 104 (preferably in the order that language(s) were selected in window 104, wherein a typed entry has priority over any other selections). Thus, the customer asks a question into the microphone using his native language, the POS terminal translates the question, and the POS terminal then displays (aurally or visually) the translation to the store employee. To communicate back to the customer, the employee likewise speaks an answer to the question into the microphone, which translates the answer back to the customer's native language (now known to the POS terminal to be the language used in the current session), and displays this answer (aurally or visually) to the customer.

Referring now to FIG. 2a, a high-level overview of (POS) terminal 202 is presented. Terminal 202 includes a display 204 for presenting the GUI 102 shown in FIG. 1. Also associated with terminal 202 is a Verbal Translation Logic (VTL) 206, which is able to recognize an oral input into a microphone associated with terminal 202 as being in a language that is not understood by the store employee, and to then translate that oral input into a language known by terminal 202 to be understood by the store employee. Logic for recognizing which language is being spoken may be based on matching a single word to a language or by matching known aural features to a language. That is, the customer may be prompted to say a single word (such as “Hello”) in his native language. VTL 206 then searches a database (such as that included in database 208) of (preferably Fast Fourier Transformed—FFT) digitized waveforms to find the closest match with a particular language. Alternatively, VTL 206 may use more sophisticated logic to search a language database according to common sounds in a language. For example, a language may be unique in its use of a particular fricative sound, and thus VTL 206, upon recognizing this fricative sound as a digitized waveform, will recognize which language is being spoken.

Terminal 202 also includes an Inventory/Information Search Logic (IISL) 210, which is used to locate information for pre-determined questions from the customer.

With reference now to FIG. 2b, data from database 208 is presented. Shown in block 208a is a listing of all languages that are not spoken by the store employee. This listing is developed by starting with all languages that can be translated by VTL 206 and removing all languages entered into window 104 (shown in FIG. 1) by the store employee.

Shown in block 208b is a list of questions with pre-defined answers for common questions that the customer may have. Note that each answer is specific for the store in which the POS terminal 202 is located, and for products that have been scanned into POS terminal 202. For example, the customer may want to know information about the store such as store hours, including special holiday store hours; if the store accepts returns for cash or store credit; if all sales are final; etc. Most questions, however, will be related to products or a particular product, such as “Is this item on sale?” “Does the coupon I just scanned in apply to this product?” “How long with this item be on sale?” “Is this item currently in style or is it last year's model?” “Does the store have more of this item in its warehouse?” “Do other stores have this item in stock?” “Does this item come in other colors/sizes?” “Does this brand of clothing come true to size, or is it smaller/larger than sized?” “Is this children's product flame retardant?” “Is this particular item pre-shrunk?” Note that these questions are only intended to be representative of the range of questions that can be automatically asked for specific products, and is not intended to be all-inclusive. While the resource shown in FIG. 2b to a specific answer may be a text file (e.g., “Yes” or “No” in response to the question about the item being on sale), the resource may also be a graphics file (e.g., the graphics file “Graphics File(1)” showing what the product looks like in another color). Similarly, the resources shown in FIG. 2b as being available to specific predetermined questions may be a link to a webpage, as identified by a Uniform Resource Locator (e.g., URL(1) for information regarding newer models of the product being considered for purchase by the customer).

Once VTL 206 translates a customer's spoken question into a language understood by database 208b (preferably by identifying keywords in the translated question), the answer to the question (in accordance with the item in question having been scanned into terminal 202) is retrieved from database 208b by IISL 210 and presented to the customer in his/her native language.

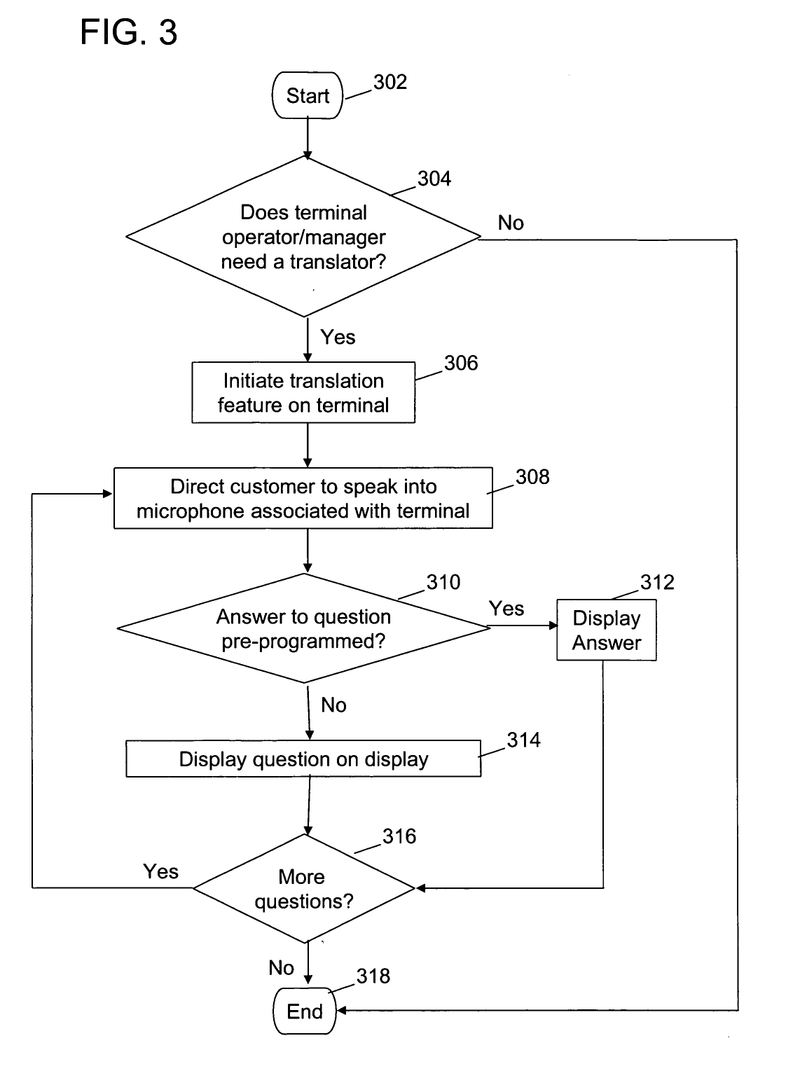

An overview of this process is shown in the flowchart shown in FIG. 3. After initiator block 302, a determination is made (query block 304) as to whether the store employee (operator/manager of the POS terminal) needs a translator. This can be determined automatically by VTL 206 as described above, or the store employee can manually select the translation functionality. If a translation is needed, VTL 206 (shown in FIG. 2a) is initiated (block 306), and the customer is directed (either by the store employee or by a graphic on the monitor for the POS terminal) to speak into the microphone (block 308). If the IISL 210 locates an answer in database 208 for the asked question, then that answer is displayed (aurally or visually) to the customer (block 312). Otherwise, the question is displayed to the store employee (aurally or in translation window 106 shown in FIG. 1). The store employee then communicates back to the customer using the same VTL 206 and GUI 102 described above.

If there are more questions (query block 316), the process continues in an iterative fashion. Otherwise, the session ends (terminator block 318).

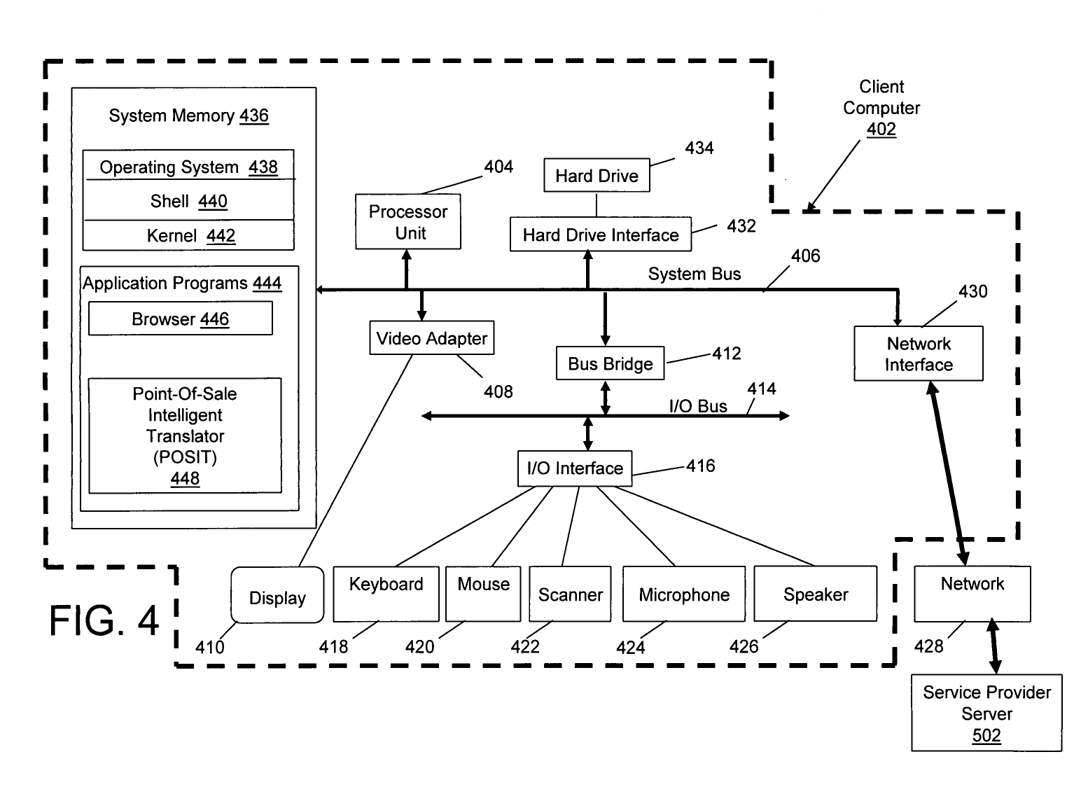

With reference now to FIG. 4, there is depicted a block diagram of an exemplary client computer 402, in which the present invention may be utilized. Client computer 402 includes a processor unit 404 that is coupled to a system bus 406. A video adapter 408, which drives/supports a display 410, is also coupled to system bus 406. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a scanner 422, a microphone 424, and a speaker 426. The format of the ports connected to I/O interface 416 may be any known to those skilled in the art of computer architecture, including but not limited to Universal Serial Bus (USB) ports.

Microphone 424 is coupled to the VTL 206, permitting a translation of words spoken into microphone 424 to be presented aurally (via speaker 426) or visually (via display 410). Similarly, scanner 422 is able to optically scan a bar code for a specific product for which a customer has a question.

Client computer 402 is able to communicate with a service provider server 502 via a network 428 using a network interface 430, which is coupled to system bus 406. Network 428 may be an external network such as the Internet, or an internal network such as an Ethernet or a Virtual Private Network (VPN). Using network 428, client computer 402 is able to use the present invention to access service provider server 502.

A hard drive interface 432 is also coupled to system bus 406. Hard drive interface 432 interfaces with a hard drive 434. In a preferred embodiment, hard drive 434 populates a system memory 436, which is also coupled to system bus 406. Data that populates system memory 436 includes client computer 402's operating system (OS) 438 and application programs 444.

OS 438 includes a shell 440, for providing transparent user access to resources such as application programs 444. Generally, shell 440 is a program that provides an interpreter and an interface between the user and the operating system. More specifically, shell 440 executes commands that are entered into a command line user interface or from a file. Thus, shell 440 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 442) for processing. Note that while shell 440 is a text-based, line-oriented user interface, the present invention will equally well support other user interface modes, such as graphical, voice, gestural, etc.

As depicted, OS 438 also includes kernel 442, which includes lower levels of functionality for OS 438, including providing essential services required by other parts of OS 438 and application programs 444, including memory management, process and task management, disk management, and mouse and keyboard management.

Application programs 444 include a browser 446. Browser 446 includes program modules and instructions enabling a World Wide Web (WWW) client (i.e., client computer 402) to send and receive network messages to the Internet using HyperText Transfer Protocol (HTTP) messaging, thus enabling communication with service provider server 502.

Application programs 444 in client computer 402's system memory also include a Point-Of-Sale Intelligent Translator (POSIT) 448.

POSIT 448 includes code for implementing the processes described in FIGS. 1-3. In one embodiment, client computer 402 is able to download POSIT 448 from service provider server 502.

The hardware elements depicted in client computer 402 are not intended to be exhaustive, but rather are representative to highlight essential components required by the present invention. For instance, client computer 402 may include alternate memory storage devices such as magnetic cassettes, Digital Versatile Disks (DVDs), Bernoulli cartridges, and the like. These and other variations are intended to be within the spirit and scope of the present invention.

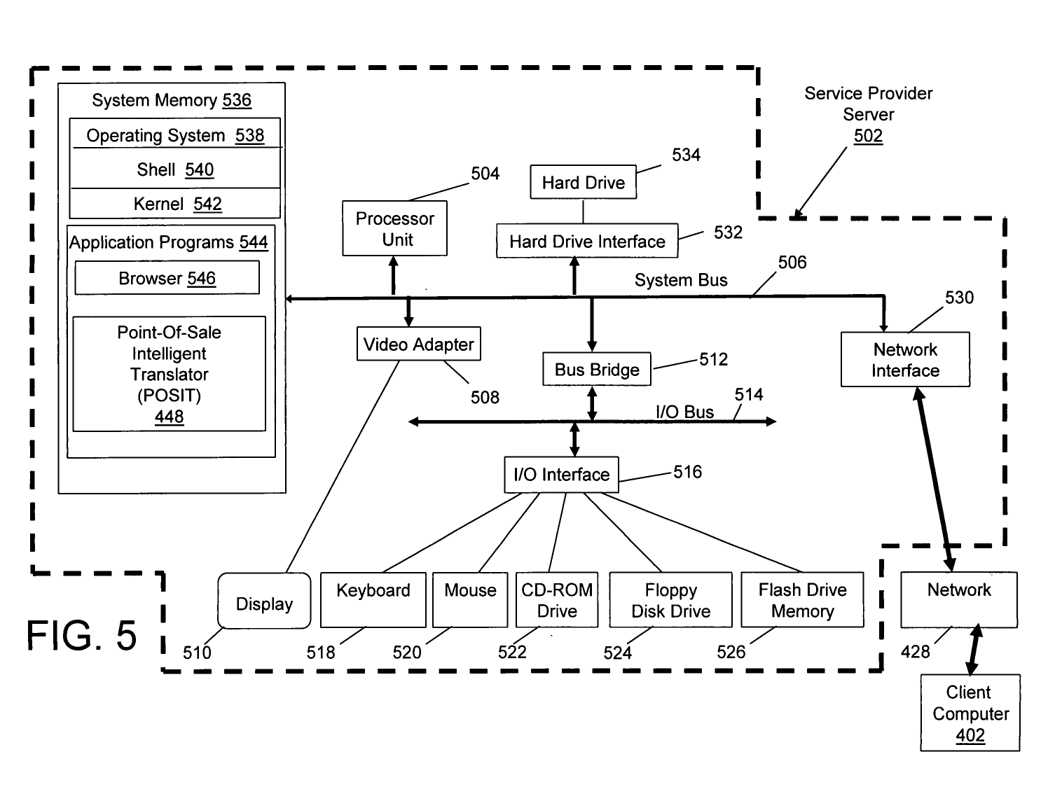

As noted above, POSIT 448 can be downloaded to client computer 402 from service provider server 502, shown in exemplary form in FIG. 5. Service provider server 502 includes a processor unit 504 that is coupled to a system bus 506. A video adapter 508 is also coupled to system bus 506. Video adapter 508 drives/supports a display 510. System bus 506 is coupled via a bus bridge 512 to an Input/Output (I/O) bus 514. An I/O interface 516 is coupled to I/O bus 514. I/O interface 516 affords communication with various I/O devices, including a keyboard 518, a mouse 520, a Compact Disk-Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

Service provider server 502 is able to communicate with client computer 402 via network 428 using a network interface 530, which is coupled to system bus 506. Access to network 428 allows service provider server 502 to execute and/or download POSIT 448 to client computer 402.

System bus 506 is also coupled to a hard drive interface 532, which interfaces with a hard drive 534. In a preferred embodiment, hard drive 534 populates a system memory 536, which is also coupled to system bus 506. Data that populates system memory 536 includes service provider server 502's operating system 538, which includes a shell 540 and a kernel 542. Shell 540 is incorporated in a higher level operating system layer and utilized for providing transparent user access to resources such as application programs 544, which include a browser 546, and a copy of POSIT 448 described above, which can be deployed to client computer 402.

The hardware elements depicted in service provider server 502 are not intended to be exhaustive, but rather are representative to highlight essential components required by the present invention. For instance, service provider server 502 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 502 performs all of the functions associated with the present invention (including execution of POSIT 448), thus freeing client computer 402 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

Thus, the method described herein, and in particular as shown and described in FIGS. 1-3, can be deployed as a process software from service provider server 502 (shown in FIG. 5) to client computer 402 (shown in FIG. 4).

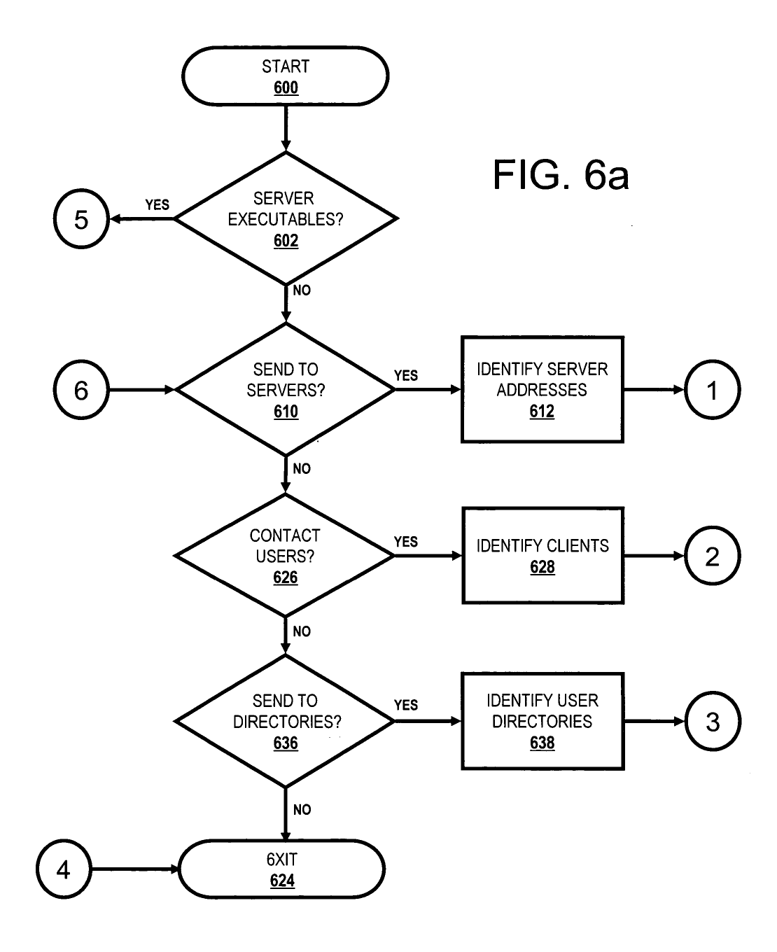

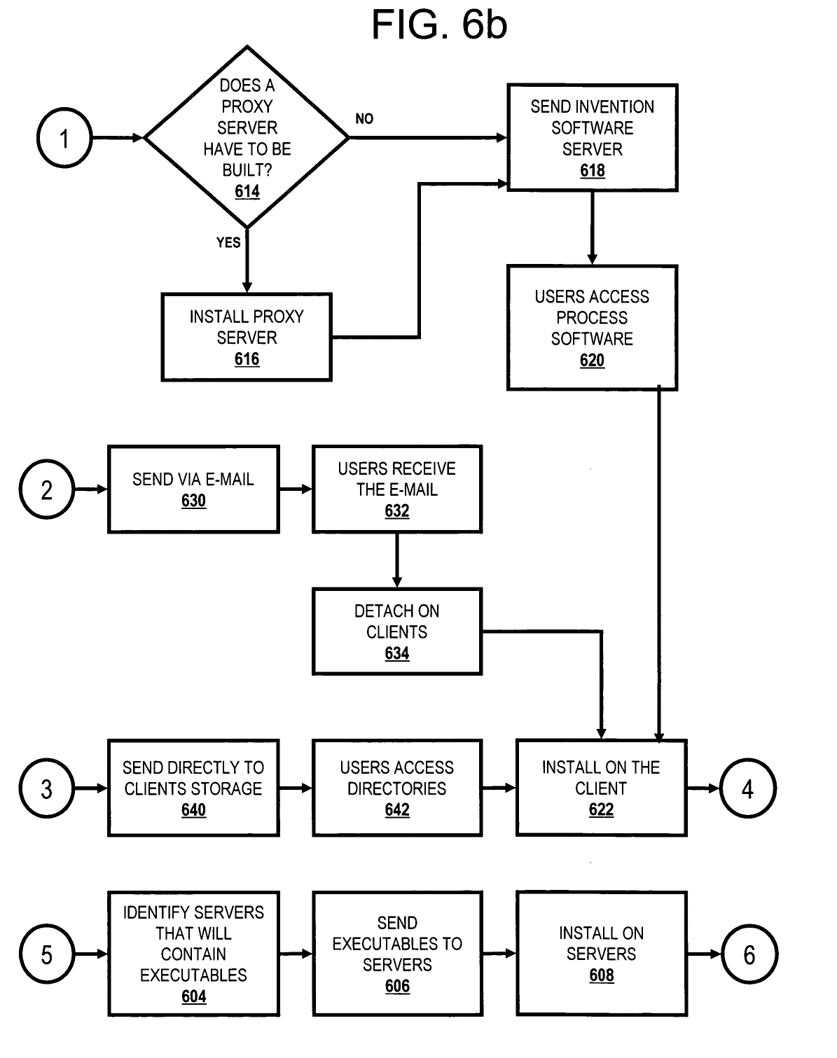

Referring then to FIG. 6, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether to the process software will be sent directly to user directories on their client computers (query block 636). If so, the user directories are identified (block 638). The process software is transferred directly to the user's client computer directory (block 640). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

VPN Deployment

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

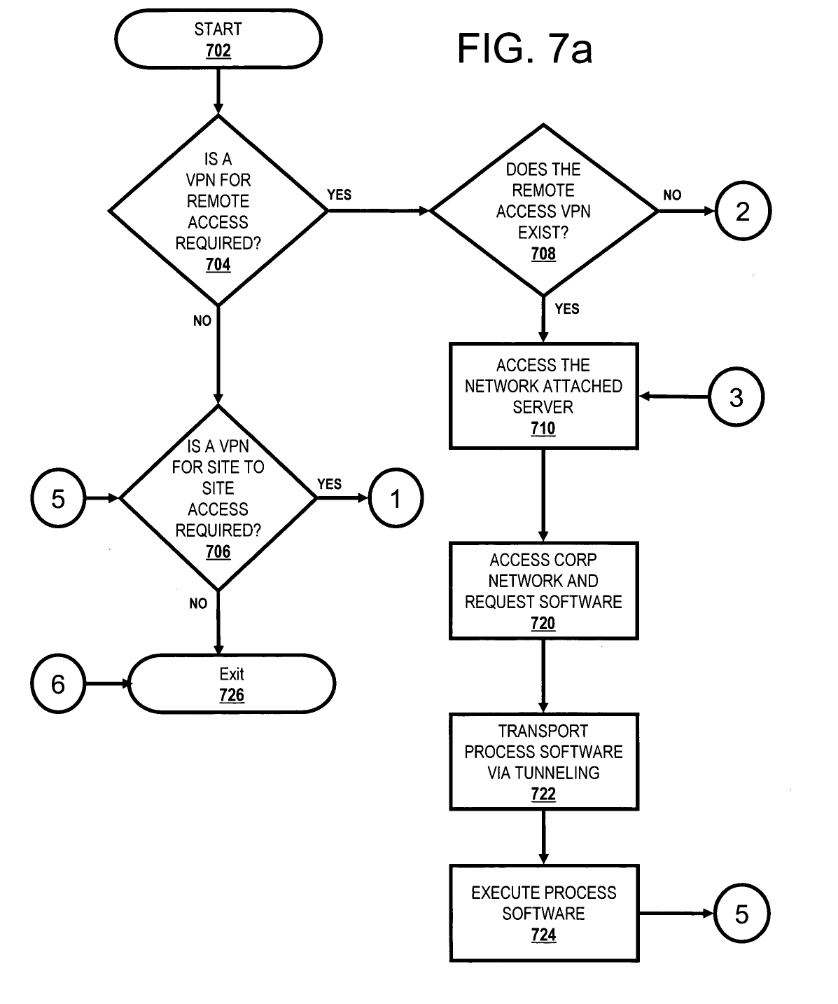

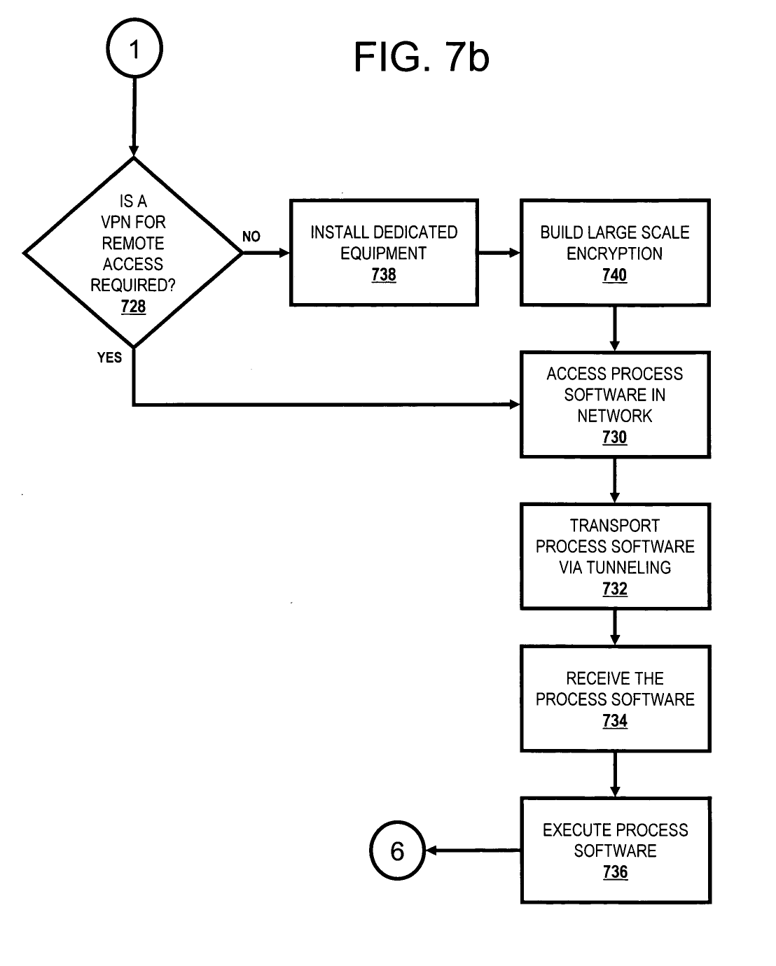

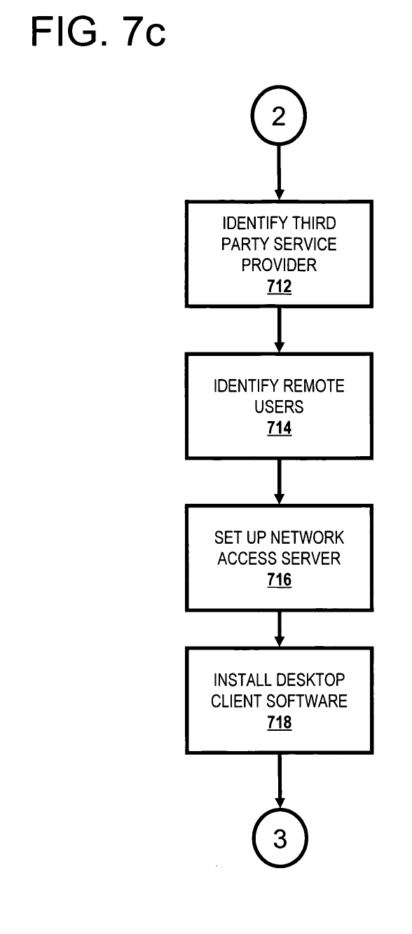

The process for such VPN deployment is described in FIG. 7. Initiator block 702 begins the Virtual Private Network (VPN) process. A determination is made to see if a VPN for remote access is required (query block 704). If it is not required, then proceed to query block 706. If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it has been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is, the process software is divided into packets and each packet including the data and protocol is placed within another packet (block 722). When the process software arrives at the remote user's desktop, it is removed from the packets, reconstituted and then is executed on the remote user's desktop (block 724).

A determination is then made to see if a VPN for site to site access is required (query block 706). If it is not required, then proceed to exit the process (terminator block 726). Otherwise, determine if the site to site VPN exists (query block 728). If it does exist, then proceed to block 730. Otherwise, install the dedicated equipment required to establish a site to site VPN (block 738). Then build the large scale encryption into the VPN (block 740).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site user's desktop (block 736). The process then ends at terminator block 726.

Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

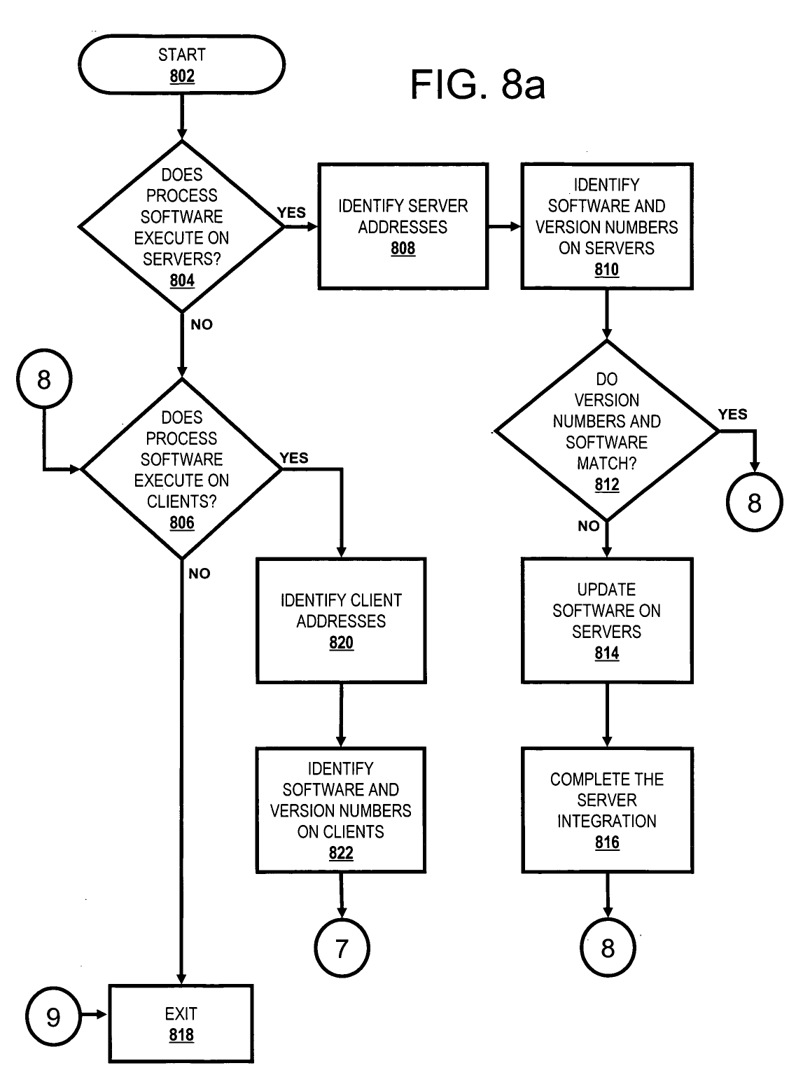

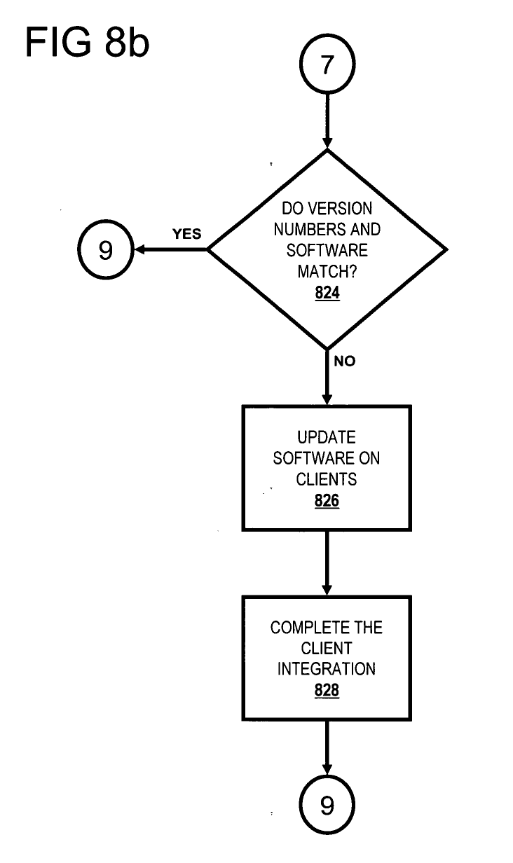

For a high-level description of this process, reference is now made to FIG. 8. Initiator block 802 begins the integration of the process software. The first tiling is to determine if there are any process software programs that will execute on a server or servers (block 804). If this is not the case, then integration proceeds to query block 806. If this is the case, then the server addresses are identified (block 808). The servers are checked to see if they contain software that includes the operating system (OS), applications, and network operating systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally, if there is missing required software, then it is updated on the server or servers in the step shown in block 814. The server integration is completed by installing the process software (block 816).

The step shown in query block 806, which follows either the steps shown in block 804, 812 or 816 determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made is the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

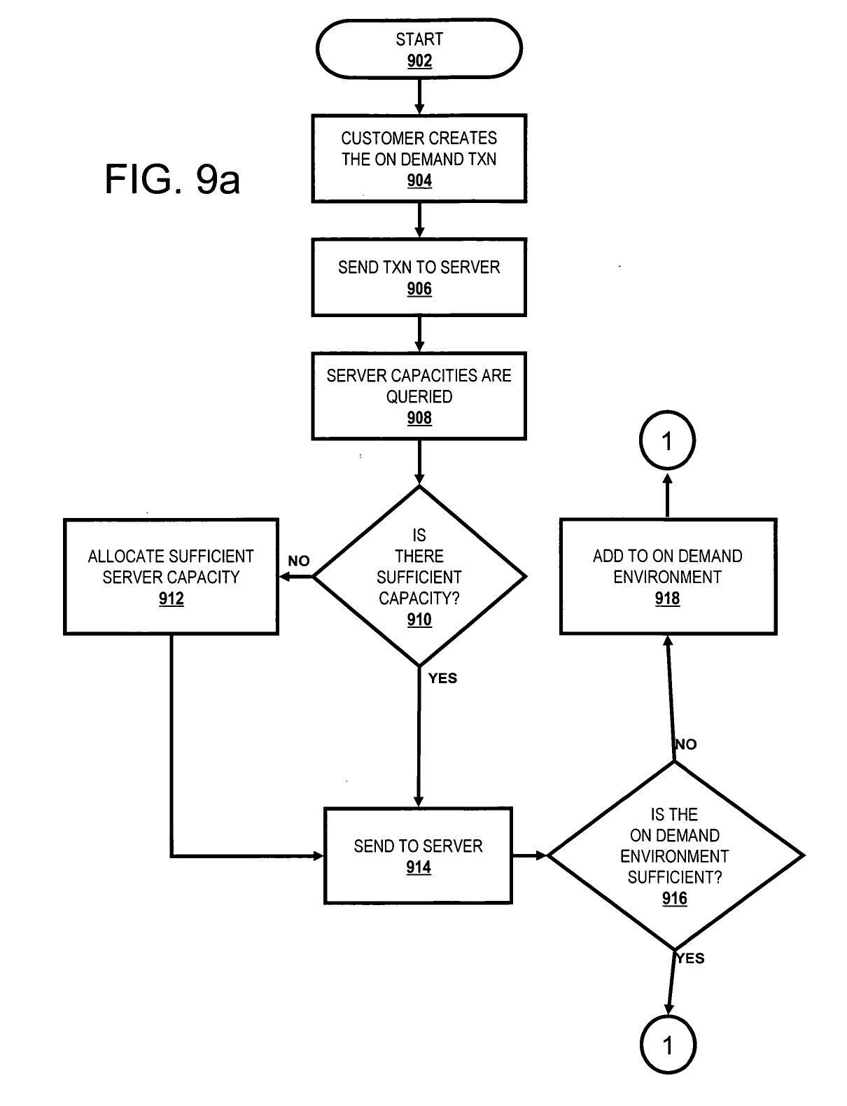

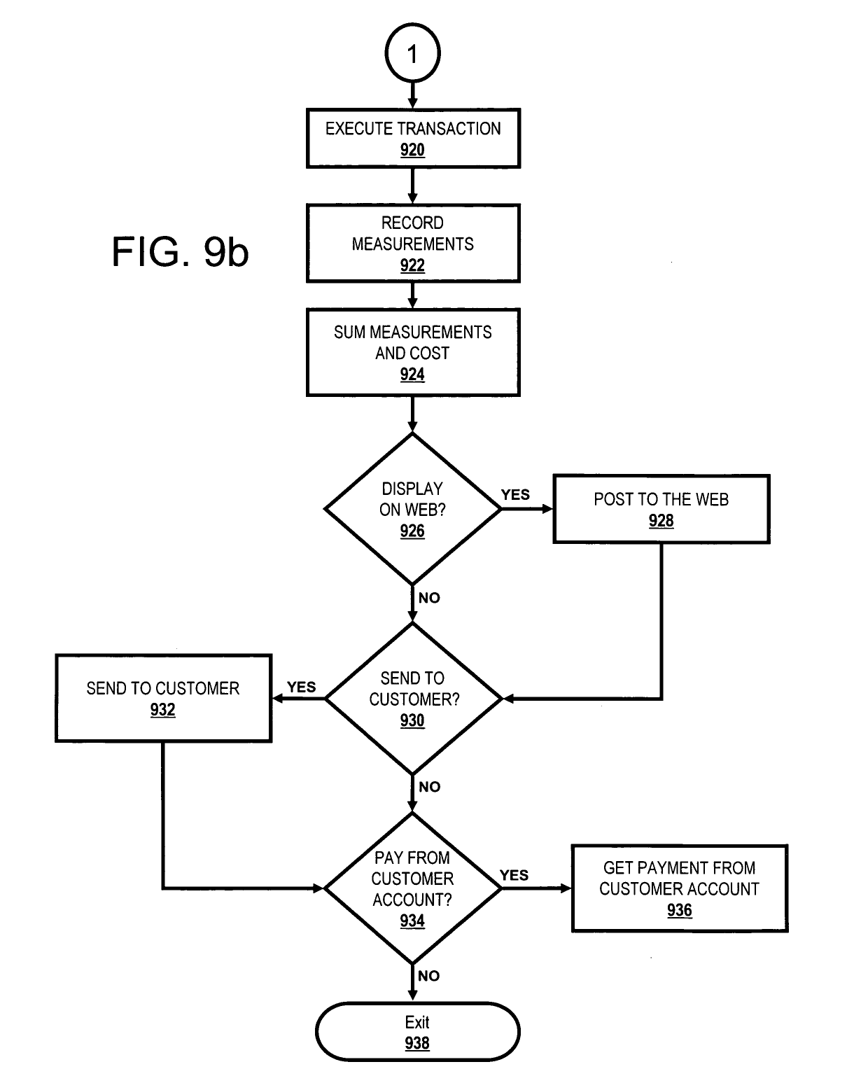

With reference now to FIG. 9, initiator block 902 begins the On Demand process. A transaction is created than contains the unique customer identification, the requested service type and any service parameters that further, specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

While the present invention has been particularly shown and described with reference to a preferred embodiment, it will be understood by those skilled in the art that various changes in form and detail may be made therein without departing from the spirit and scope of the invention. For example, while the present invention has been described as being used at a POS terminal, the invention as described may be implemented at any computer-facilitated station in which language barriers present a problem. Thus, the present invention may be utilized in a customer assistance station, a manned information kiosk, a tablet computer, a cell phone, a hand-held device (e.g., a Personal Digital Assistant—PDA) that communicates between a consumer and a retailer, etc. Similarly, it is understood that the term “operator” as used in the claims is defined as being a person who exercises management and operation of a public terminal (e.g., a POS terminal) on a permanent basis, as opposed to a “customer” who is understood to be a transient user, who uses the public terminal only under the supervision of the operator.

Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method comprising:
receiving, at a public terminal, a verbal input from a customer speaking a foreign language, the foreign language being unintelligible to an operator of the public terminal;
translating, by the public terminal, the verbal input into a language that has been predetermined as being understandable by a specific operator of the public terminal; and
presenting the translated verbal input to the specific operator.

2. The method of claim 1, further comprising:
storing in the public terminal a list of foreign languages that are not understood by the specific operator; and
using software that is associated with the public terminal to recognize the verbal input as being in a language from the list of foreign languages that are not understood by the specific operator.

3. The method of claim 1, wherein the verbal input is a verbal question presented to a store employee via a microphone on a Point-Of-Sale (POS) terminal, the method further comprising:
storing a list of predetermined questions that may be asked by foreign language speaking customers;
storing a list of resources, wherein each resource in the list of resources corresponds to, and provides an answer to, one of the predetermined questions;
matching an appropriate resource from the list of resources to a verbal question asked by the customer; and
presenting the appropriate resource to the customer.

4. The method of claim 3, wherein the appropriate resource is a graphics file that is presented to the customer visually at the POS terminal.

5. The method of claim 3, wherein appropriate resource is a text file related to information about a product being paid for at the POS terminal.

6. The method of claim 3, wherein the predetermined questions are questions about a store that utilizes the POS terminal.

7. A system comprising:
a processor;
a data bus coupled to the processor; and
a computer-usable medium embodying computer program code, the computer-usable medium being coupled to the data bus, the computer program code comprising instructions executable by the processor and configured for:
receiving, at a public terminal, a verbal input from a customer speaking a foreign language, the foreign language being unintelligible to an operator of the public terminal;
translating, by the public terminal, the verbal input into a language that has been predetermined as being understandable by a specific operator of the public terminal; and
presenting the translated verbal input to the specific operator.

8. The system of claim 7, wherein the instructions are further configured for:
storing in the public terminal a list of foreign languages that are not understood by the specific operator; and
using software that is associated with the public terminal to recognize the verbal input as being in a language from the list of foreign languages that are not understood by the specific operator.

9. The system of claim 7, wherein the verbal input is a verbal question presented to a store employee via a microphone on a Point-Of-Sale (POS) terminal, the method further comprising:
storing a list of predetermined questions that may be asked by foreign language speaking customers;
storing a list of resources, wherein each resource in the list of resources corresponds to, and provides an answer to, one of the predetermined questions;
matching an appropriate resource from the list of resources to a verbal question asked by the customer; and
presenting the appropriate resource to the customer.

10. The system of claim 9, wherein the appropriate resource is a graphics file that is presented to the customer visually at the POS terminal.

11. The system of claim 9, wherein appropriate resource is a text file related to information about a product being paid for at the POS terminal.

12. The system of claim 9, wherein the predetermined questions are questions about a store that utilizes the POS terminal.

13. A computer-usable medium embodying computer program code, the computer program code comprising computer executable instructions configured for:
receiving, at a public terminal, a verbal input from a customer speaking a foreign language, the foreign language being unintelligible to an operator of the public terminal;
translating, by the public terminal, the verbal input into a language that has been predetermined as being understandable by a specific operator of the public terminal; and
presenting the translated verbal input to the specific operator.

14. The computer-usable medium of claim 13, wherein the embodied computer program code further comprises computer executable instructions configured for:
storing in the public terminal a list of foreign languages that are not understood by the specific operator; and
using software that is associated with the public terminal to recognize the verbal input as being in a language from the list of foreign languages that are not understood by the specific operator.

15. The computer-usable medium of claim 13, wherein the verbal input is a verbal question presented to a store employee via a microphone on a Point-Of-Sale (POS) terminal, the method further comprising:
storing a list of predetermined questions that may be asked by foreign language speaking customers;
storing a list of resources, wherein each resource in the list of resources corresponds to, and provides an answer to, one of the predetermined questions;
matching an appropriate resource from the list of resources to a verbal question asked by the customer; and
presenting the appropriate resource to the customer.

16. The computer-usable medium of claim 15, wherein the appropriate resource is a graphics file that is presented to the customer visually at the POS terminal.

17. The computer-usable medium of claim 15, wherein appropriate resource is a text file related to information about a product being paid for at the POS terminal.

18. The computer-usable medium of claim 15, wherein the predetermined questions are questions about a store that utilizes the POS terminal.

19. The computer-useable medium of claim 13, wherein the computer executable instructions are deployable to a client computer from a server at a remote location.

20. The computer-useable medium of claim 13, wherein the computer program code is provided by a service provider to a customer on an on-demand basis.
